(19) United States
(12) Patent Application Publication
(10) Pub. No.: US 2016/0170098 A1
(43) Pub. Date: Jun. 16, 2016

(54) CONSTRUCTION OF HYPERBOLIC METAMATERIAL FOR AN OPTICAL SPECTRAL RANGE

(71) Applicants: King Abdul Aziz City for Science and Technology, Riyadh (SA); B.I. Stepanov Institute of Physics of the National Academy of Sciences of Belarus, Minsk (BY)

(72) Inventors: Mukhurov Nikolai Ivanovich, Minsk (BY); Mohammed A. Binhussain, Riyadh (SA); Alshammari Marzook Saleh, Riyadh (SA); Alarifi Hani Abdulkareem, Riyadh (SA); Gasenkova Irina Vladimirovna, Minsk (BY); Kazak Nikolai Stanislavovich, Minsk (BY); Belyi Vladimir Nikolaevich, Minsk (BY)

(73) Assignees: King Abdul Aziz City for Science and Technology, Riyadh (SA); B.I. Stepanov Institute of Physics of the National Academy of Sciences of Belarus, Minsk (BY)

(21) Appl. No.: 14/934,592

(22) Filed: Nov. 6, 2015

(30) Foreign Application Priority Data
Dec. 12, 2014 (BY) U20140450

(51) Int. Cl. G02B 5/00; G02B 1/00

(52) U.S. Cl. CPC G02B 5/008; G02B 1/007; Y10S 977/762; Y10S 977/81; B82Y 20/00

(57) ABSTRACT

Construction of hyperbolic metamaterial for electromagnetic radiation in an optical spectral range is described. Example processes relate to the technical art of metamaterials of the optical region of wavelengths and can be applied for creation of artificial materials changing the features in optical region of wavelengths. An example process widens the working region of wavelengths due to periodic system of nanorods in a definite range of diameters and heights. An example construction is fulfilled of aluminum oxide ceramics with periodic system of nanoholes with the diameters from 30 till 50 nm are filled with the particles of noble metals forming metal nanorods with the height from 3 till 10 diameters of pores from the side of the surface of dielectric substrate turned toward the source of electromagnetic radiation. To provide mechanical strength the thickness of the substrate should be not less than 30 μm.

The construction of hyperbolic metamaterial relates to the area of metamaterials of the optical region of wavelengths and can be applied for creation of artificial materials changing the features in optical region of wavelengths.

Two constructions of metamaterial are known, which are to be used for the operation in an optical region of wavelengths [1] being an interchange of layered metal-dielectric nanostrucutres and medium on the basis of ordered unidirectional nanorods.

Every of these constructions have been calculated for a narrow region of wavelengths.

The medium of metal nanorods formed by filling with metal of dielectric matrix, first of all matrix of nanoporous anodic aluminum oxide (AAO) filled with noble metal [2], is the closest on construction. But like other constructions this one is calculated for a narrow working region of wavelengths.

The technical problem of the invention is the widening of the working region of wavelengths due to periodic system of nanorods in a definite range of diameters and heights.

The solution of the technical problem is achieved that the construction of the hyperbolic metamaterial for electromagnetic radiation in an optical spectral range contains the dielectric substrate with periodic system of nanoholes along the whole area of the surface filled with noble metals. Nanoholes with the diameters from 30 up to 50 nm are filled with noble metals forming nanorods with the height from 3 up to 10 diameters of nanorods from the side of the surface turned toward the source of electromagnetic radiation and dielectric substrate has the thickness not less than 30 μm.

The combination of the pointed features provides the widening of a working region of wavelengths of the construction of hyperbolic metamaterial, wherein the properties appear of metamaterial due to the presence of evenly distributed on the whole volume of alumina oxide substrate periodic nanopores with the diameters within the range from 30 up to 50 nm filled with noble metal, which forms the system of metal nanorods with the height from 3 up to 10 diameters of pores in a dielectric substrate.

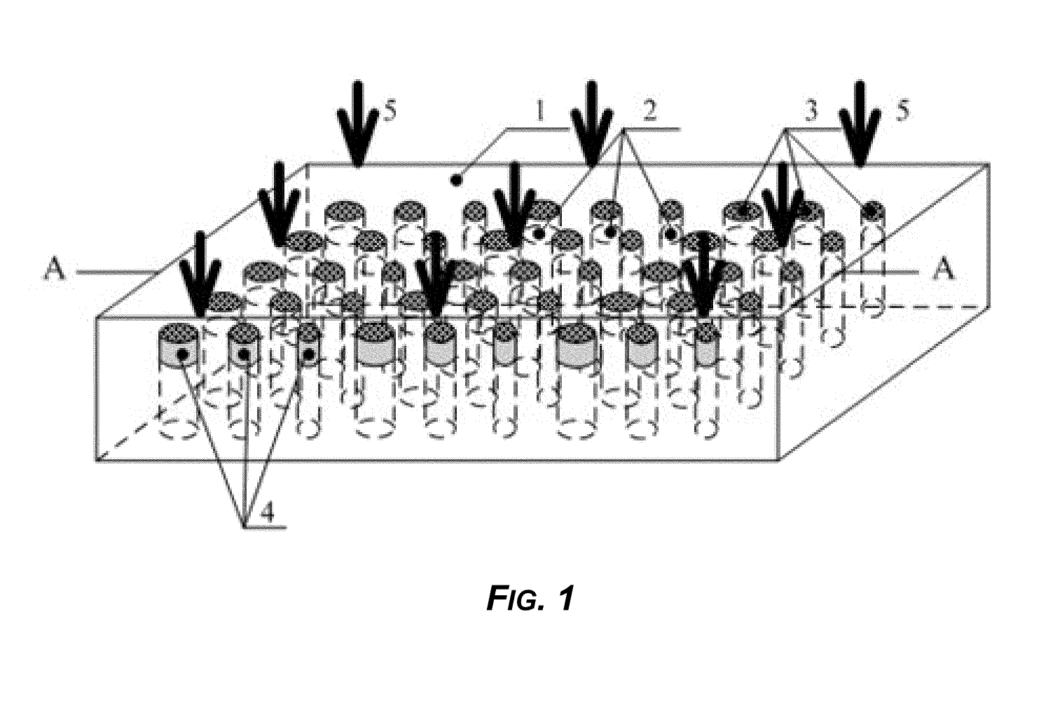

The essence of the invention is given in FIGS. 1,2.

FIG. 1 illustrates the schematic image of the construction of hyperbolic metamaterial containing:

1—dielectric substrate,

2—nanoholes,

3—noble metal,

4—nanorods,

5—electromagnetic radiation.

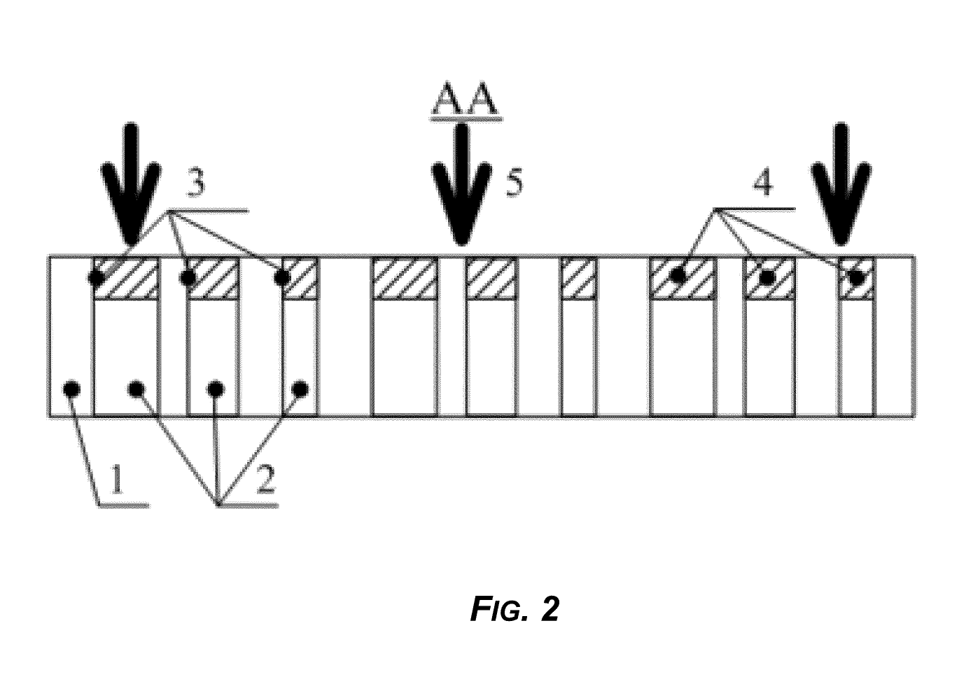

FIG. 2 shows the schematic image of the cuts of separate nanoholes 2 filled with noble metal 3, with nanorods 4 from the side of the surface of dielectric substrate 1 turned toward the source of electromagnetic radiation 5.

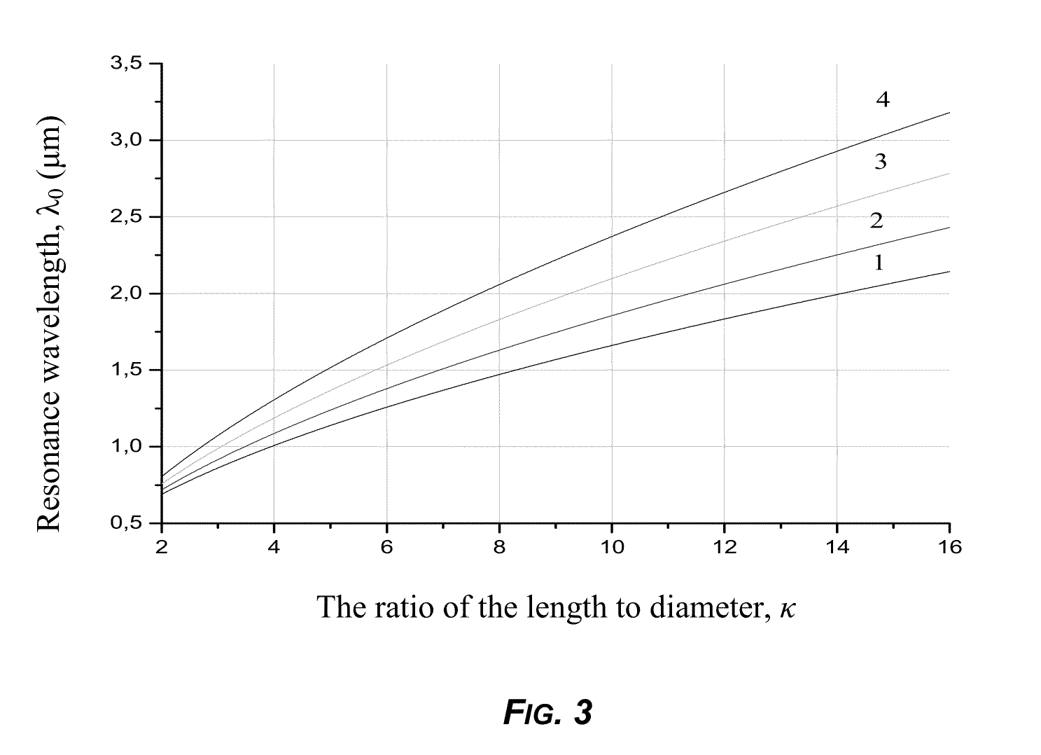

In FIG. 3 the dependences are given of the wavelength of plasmon resonance λ₀ as a ratio function I/2r₀ at various radiuses of nanorod r₀

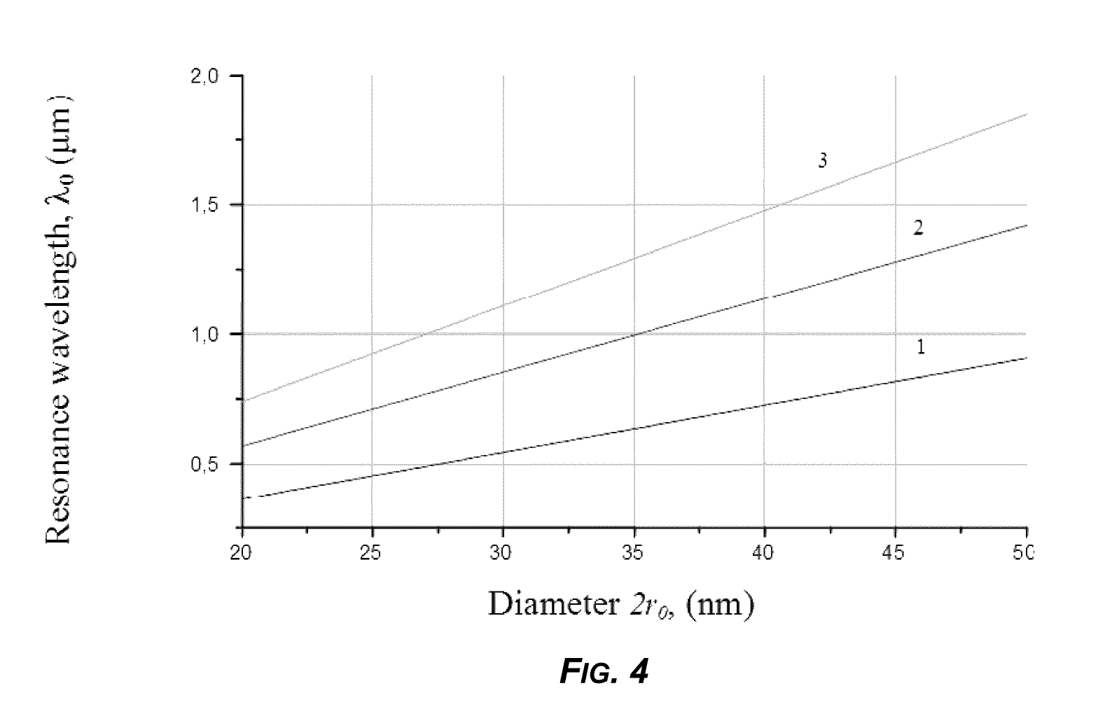

In FIG. 4 the dependence is shown of the resonance wavelength on the diameter of nanorod at various values of geometrical parameter κ=I/2r₀.

The construction of hyperbolic metamaterial consists of the dielectric substrate 1 and the system of alternating nanoholes 2 with various diameters filled with noble metal 3. The dielectric substrate 1 is fulfilled of anodic aluminum oxide (Al₂O₃) and has a periodic system of parallel to each other nanoholes 2 with the diameter from 30 up to 50 nm (FIG. 2), which are filled with the particles of noble metal 3 (FIG. 3) forming the periodic system of nanorods 4 in the upper part of the dielectric substrate 1 turned toward the source of electromagnetic radiation 5. The height of nanorods 4 from the surface of the dielectric substrate 1 turned toward the source of electromagnetic radiation 5 is the values equal to 3-10 diameters of nanorods 4. Due to the fulfillment of the construction in a form of periodic systems of alternating to perpendicular surfaces of the dielectric substrate 1 metal nanorods 4 with the diameters within the range from 30 up to 50 nm, where as a metal there are used noble metals and as a dielectric—aluminum oxide, the widening of the working region of wavelengths of the construction of hyperbolic metamaterial is achieved. The results of the below-given theoretical calculations allow one to optimize the geometrical sizes of the periodic system of nanorods 4, including ones for definite noble metals 3.

Dielectric substrates 1 are manufactured of anodic aluminum oxide by the method of chemical oxidation of aluminum and have the periodic system of nanoholes 2, the diameters of which amount to from 30 up to 50 nm. Filling of nanoholes 2 with particles of noble metal 3 is conducted using electrochemical method allowing a high level of controlling the height of filling of separate nanoholes 2. To provide the efficient mechanical strength of the substrate of anodic aluminum oxide the thicknesses are formed not less than 30 μm.

Theoretical calculation of the construction of hyperbolic metamaterial.

It is known that at illumination of the system of metal rods by an incident light beam near every rod plasmon fields [3] appear, which are the collective vibrations of electrons of conductivity and electric field. The maximal electric field is observed in conditions of plasmon resonance. Such resonance is accompanied by the essential strengthening of electrical field in near-surface area of nanorod.

Surface plasmons are the reason for appearing of negative refraction of composite materials created on the basis of ordered nanorods implemented into the dielectric matrix. One of perspective metamaterials of such a class is porous films of aluminum oxide Al₂O₃, pores of which are filled with noble metals (silver, gold, copper and so on). The conditions of appearing of plasmon resonances in the system of ordered nanorods (particularly, resonance wavelength) depends essentially on the parameter κ=l/d, i.e. ratio of length l to its diameter d. The typical lengths of nanorods vary from 200 nm up to 1000 nm and their diameters—from 20 nm up to 70 nm. Such parameters of nanorods allow one to make the negative refraction in visible, near and mid IR ranges of electromagnetic spectrum.

Physically transparent and suitable for calculation of wavelengths of plasmon resonance is the presentation of nanorod in a form of electrical chain containing inductance and capacitance [4]. At not very small distance between nanorods in Al₂O₃ matrix, every nanorod can be studied isolated from each other. Further let us examine the conditions of appearing of longitudinal resonance, when the electrical vector of the excited light wave is directed along the axis of nanorod having the length l and radius r₀. It is also supposed that the nanorod radius is less than the depth Γ of skin-effect (r₀<δ).

It is shown that the nanorod can be studied as LC circuit having capacitance C and inductance L. It is connected with the fact that under the influence of the electrical field of light wave in the nanorod the electrical current I arises, which is accompanied by the magnetic field being proportional to the current. Here the energy of the magnetic field inside the nanorod is essentially smaller than the energy outside the nanorod covering the cylinder hole with the length l and also internal radius r₀ and external radius l/2. From the equality of the energy of the magnetic field in the cylinder area to the full energy W=LI²/2, the expression for self-inductance L follows:

$$L = \frac{l}{{c}^{2}} ln ( \frac{l}{2 {r}^{0}} ) , \qquad ( 1 )$$

which is mainly determined by the nanorod length l.

Under the influence of alternating electric field w of light wave the nanorod preserves the variable resistance R=R₀−iωLₒ, where R₀=l/σ₀s (σ₀—is the conductivity, s is the area of nanorod section), and L₀=4πl/c²Kₚ²s is the traditional usual inductance, here Kₚ=ωₚ/c, ωₚ is the volume plasmon frequency.

Thus, the presence of variable resistance of the nanorod can be studied as consequent inclusion of constant resistance R₀ and usual inductance L₀, which is inversely to the area of transverse section of the nanorod. As a consequence of appearing of the alternating current at the ends of nanorod electrical charge ±q of the inverse sign is induced. That is why the nanorod can be studied as a condensator preserving effective capacitance C:

$$C = \frac{1}{4} {αɛ}_{d} {r}_{0} , \qquad ( 2 )$$

where α is the correcting factor taking into account inhomogeneity of distribution of charge at the ends of nanorod and being equal to approximately α=2.5 [4]. It follows from Eq. (1.2) that electro-capacitance of the nanorod depends on its radius and dielectric permittivity of the environment.

Thus, according to Eqs. (1) and (2) the influence of electric field on nanorod can be presented within the model of LC electrical circuit having definite inductance and electro-capacitance. In such a circuit electromotive force (EMF) E=I(R−iωL+i/ωC) arises determined by electrical field E of incident light wave: E=∫Edl=El. As on the opposite sides of the nanorod variable in time charges arise with the contrary sign ±q, then this nanorod is equivalent to the electric dipole with dipole momentum p=ql. Using the Ohm laws and equations for current I=dq/dt it is possible to obtain equation for dipole momentum of the nanorod:

$$p = \frac{A}{{ω}_{0}^{2} - {ω}^{2} - iη ω} E , \qquad ( 3 )$$

where A=I²/(L₀+L), ω₀=1/\sqrt{(L₀+L)C}, η=R₀/(L₀+L). From Eq. (3) it follows that the excited nanorod can be studied as a resonator with the Lorentz contour.

According to Eq. (3) the frequency ω₀ of plasmon resonance is determined through the inductance L₀, L and electro-capacitance C in the following way:

ω₀−1/\sqrt{(Lₒ+L)C} (4)

From Eq. (4) the expression follows for the length of light wave λ₀=2πc/ω₀, on which the plasmon resonance is realized:

λ₀=πn_{d}\sqrt{10κ(2δ²+r₀² ln κ),} (5)

where n_{d} is the refraction index of the surrounding dielectric, κ=l/2r₀, δ=c/ω is the depth of skin-effect for metal.

For nanorod of silver (ωₚ=1.39×10¹⁶ c⁻¹) we have for the depth of skin-effect δ=21.6 nm.

It follows from Eq. (5) that λ₀ is the nonlinear function of the parameter κ [4].

Using Eq. (5) the resonance wavelengths λ₀ have been calculated. Dependences of the wavelength of plasmon resonance λ₀ as a function of ratio l/2r₀ at difference radiuses of the nanorod r₀ are shown in FIG. 3.

The dependence of resonance wavelength λ₀ on parameter κ=l/2r₀ at various diameters 2r₀ of nanorods of silver in Al₂O₃ matrix 1—2r₀=20 nm, 2—2r₀=30 nm, 3—2r₀=40 nm, 4—2r₀=50 is shown in FIG. 3.

FIG. 4 shows that at ratio of nanorod length to its diameter equal to three or less the resonance length of the plasmon is realized in the visible region of the optical range for diameters of nanorods from 20 up to 40 nm. For values κ=l/2r₀ within 8-12, the resonance wavelength of plasmon exists in near IR-region (from 1.5 μm up to 2.5 μm) for diameters of nanocylinders from 20 up to 50 nm. Principally, using dependences in FIG. 4 it is possible to determine the wavelength of plasmon resonance for the system of isolated nanorods of silver for any before-set ratio of nanocylinder length to its diameter.

The dependence of resonance wavelength λ₀ on the diameter 2r₀ of nanorod of silver in Al₂O₃ matrix at various values of geometrical parameter κ 1—κ=4; 2—κ=7 3-10 is shown in FIG. 4.

The dependence of the resonance wavelength on the diameter of nanocylinder at various values of geometrical parameter k is shown in FIG. 4.

In its turn the plots in FIG. 5 allow one to determine the wavelength of plasmon resonance of two-dimensional array of nanorods for any set diameter ranging from 20 up to 50 nm.

The direction of electromagnetic radiation 5 from the side of the surface of dielectric substrate 1, on which the faces of metal nanorods 4 emerge, does not make weaker the input signal unlike the variant with the direction of electromagnetic radiation 5 from the side of the surface with unfiled with noble metal 3 nanopores 2. In the last case essential weakening of electromagnetic radiation 5 will be observed.

It is determined experimentally that the fulfillment of the dielectric substrate 1 with the thickness not less than 30 μm provides necessary mechanical strength of the construction of metamaterial.

### REFERENCES

1. W. Cai and V. Shalaev. Optical Metamaterials: Springer, 2010.
2. Constantin R. Simovski, Pavel A. Belov, Alexander V. Atrashchenko, and Yuri S. Kivshar. Wire Metamaterials: Physics and Applications//Adv. Mater. 2012. P. 1-20.
3. S. A. Maier. Plasmonics: Fundamental and applications (Springer, New York, 2007).
4. Cheng-Ping Huang, Xiao-Gang Yin, Huang Huang, and Yong-Yuan Zhu. Study of plasmon resonance in a gold nanorod with an LC circuit model//Optics Express, Vol. 17, Issue 8, pp. 6407-6413 (2009).

1. An apparatus, comprising:
a hyperbolic metamaterial for electromagnetic radiation in an optical spectral range;
a dielectric substrate of the hyperbolic metamaterial comprising a periodic system of nanoholes over an entire area and filled with a noble metal;
wherein nanoholes of the periodic system of nanoholes have diameters in a range between approximately 30-50 nanometers;
wherein the nanoholes are filled with noble metals forming metal nanorods with a height ranging from 3-10 times the diameters of the metal nanorods;
wherein the metal nanorods are turned toward a source of electromagnetic radiation; and
wherein the dielectric substrate has a thickness of at least 30 micrometers (μm).
